(19) United States
(12) Patent Application Publication
(10) Pub. No.: US 2002/0046047 A1
(43) Pub. Date: Apr. 18, 2002

(54) Patient care management system and method

(76) Inventor: Jeffrey R. Budd, Shoreview, MN (US)

Correspondence Address: Robert C. Beck, Beck & Tysver, P.L.L.C., Suite 100, 2900 Thomas Avenue S., Minneapolis, MN, 55416, US

(21) Appl. No.: 09/899,774

(22) Filed: Jul. 5, 2001

Related U.S. Application Data
(60) Provisional application No. 60/216,655, filed on Jul. 7, 2000.

(51) Int. Cl. G06F 17/60

(52) U.S. Cl. 705/1

(57) ABSTRACT

The present invention is related generally to a computerized system for monitoring, tracking and improving a patient's health. The system includes optional monitors which measure physiologic variables of the patient at a remote location such as the home, and transmits this information to a centralized office. Caregivers in the office monitor individual patients and make recommendations for patient monitoring and care based upon both the individual patients condition and progress as well as others within the system who are similarly situated. The system may operate over the World Wide Web and patient monitoring may include questionnaires and other forms of patient interaction.

### CROSS REFERENCE TO RELATED CASES

The present applicant claims the benefit of provisional Application Ser. No. 60/216655 filed Jul. 7, 2000.

### FIELD OF THE INVENTION

The present invention relates generally to the field of patient care management and more particularly to a system that facilitates interaction between a patient, a health caregiver and a system administrator.

### DEFINITIONS

Algorithm: A calculation based on incoming and past patient data that determines the current health status of the patient.

Caregiver: A person who interacts with the care management system to care for a patient. This includes a care manager, doctor, nurse specialist or a member of the patient's family.

Care manager: A person whose job is to remotely manage the care of a patient.

Data: The information collected from the patient or his/her caregivers in order to formulate the best care for that patient.

Database: A facility that stores all data required to perform remote patient care. This includes questions answered and measurements taken by the patient, status and events received from the patient or caregivers and tasks performed by care managers on the patient's behalf.

Educational material: Information sent to patients to help them understand their therapy regimen, their health status, their prognosis or ways they can better manage their daily living tasks.

Home monitor: A device at the patient's residence that provides a textual and graphical interface to the patient, connects to the measurements devices in the residence and remotely connects to the medical station server. It and the measurement devices comprise the medical station.

Information: Test and/or graphical material sent to the patient which is either a message, educational material or questions that the patient is requested to answer.

Measurement device: A device in the patient's residence that provides a physiological measurement on the patient. One or more of these may connect directly to the home monitor; this combination comprises the medical station.

Medical station: The home monitor plus the measurement devices connected to it.

Message: A greeting and/or informative text sent to a patient via the home monitor that is specific to that patient and his/her status.

Optimal health care track (OHCT): The coordinating set of rules, parameters and status knowledge on a specific patient that is used to generate tasks and information for that patient.

Questions: A set of queries the patient is asked to answer when he/she interacts with the medical station. Questions are individually generated by the OHCT and by caregivers for a specific patient. They can be either subjective queries or objective, quantifiable measurements from measurement devices not directly connected to the home monitor.

Parameter: A quantitative qualifier on a more general rule that customizes that rule for applicability to that specific patient.

Rule: An if-then statement used to help direct patient care management. Specific rules are applicable to patients of a given status or change in status. Rules use algorithms and patient parameters within an “if” statement to initiate the “then” clauses. A “then” clause generates either a change in status, a task for a care manager or information to be sent to the patient.

Rulebase: A facility that stores all the rules of the care management system and that can retrieve those rules applicable to any specific patient.

Status: Current status of a patient related to his/her medical problem, the severity of that problem, the goals of that patient, how close that patient is to his/her goals, and the knowledge that patient possesses.

System administrator: A person that oversees the proper operation of the care management system. He/she monitors updates to the rulebase for appropriateness and oversees the task manager to maintain proper and efficient operation.

Task: A set of actions performed by a caregiver to help a patient improve or maintain his/her health, achieve a desired goal or increase his/her knowledge. A task can be self generated by a caregiver or generated by the patient's OHCT.

Task manager: A coordinating software process that provides a list of tasks for a care manager to perform. It notes those tasks that have been performed and stores them in the database.

Update: A process of changing or adding rules to the rulebase or changing or adding parameters to a patient's OHCT.

User interface (UI): A display and entry capability that allows a person to interact with the care management system.

### BACKGROUND OF THE INVENTION

Computerized patient records and patient care tracking systems are known in the art. More recently “telemedicine” systems have been proposed for diagnostic and therapeutic treatment of patient in the home setting.

An example of a system for managing care is known form U.S. Pat. No. 5,826,237 and an example of a remote diagnostic system is known from U.S. Pat. No. 5,851,186.

Although the use of networks and computers to enhance patient care are well known there are serious obstacles to the use of this technology to improve patient care.

### SUMMARY OF THE INVENTION

In contrast to the prior art, the system of the present invention tracks the medical outcomes for a specific patient who is given specific care. In the present invention, the care and outcomes for each specific patient are available in a large database; this database and a set of patient care rules residing in a rule base are used to create a care strategy individualized for each patient. Trends and observations that improve care, which are known from the totality of care scenarios, are used to continually revise and personalize the particular health care strategy supplied to an individual patient.

The system is most conveniently carried out over a communication network such as the worldwide web. An illustrative partitioning of the system includes a patient at home interacting with a medical station the medical station is coupled to a network and data packets are received at a remote data management site (DMS). A caregiver (CG) also communicates with the remote site DMS through a CGUI. The caregiver and patient can typically communicate via voice through a telephone line. The CG any also interact with FM or doctor via phone line as well. Any human can initiate a contact but a task manager software structure informed by a rule base and a database may also initiate a contact or other action. Various examples are given in the text.

In general, the Rulebase is the repository for decision-making software that governs patient management. The rulebase is informed and modified by the database that records outcomes. Each patient is assigned an OHCT which is unique to the patient and which details appropriate interactions between the patient and the care giver. A task manager software module monitors the interactions between the patient and the CG to update the OHCT.

In a typical scenario, the communication between the MS and P, initiated by the TM, reduces the need for CG to P voice communication and therefore optimizes communications in terms of content, duration and frequency.

### BRIEF DESCRIPTION OF THE DRAWINGS

FIG. 1 is a structural diagram representing the physical portion of the system and the software structures.

FIG. 2 is a flowchart implementing a software process.

FIG. 3 is an object interaction diagram for physical processes and software process steps.

FIG. 4 is a flowchart implementing a software process.

FIG. 5 is an object interaction diagram for physical processes and software process steps.

FIG. 6 is an object interaction diagram for physical processes and software process steps.

FIG. 7 is an object interaction diagram for physical processes and software process steps.

FIG. 8 is a flowchart implementing a software process.

FIG. 9 is an object interaction diagram for physical processes and software process steps.

### DETAILED DESCRIPTION

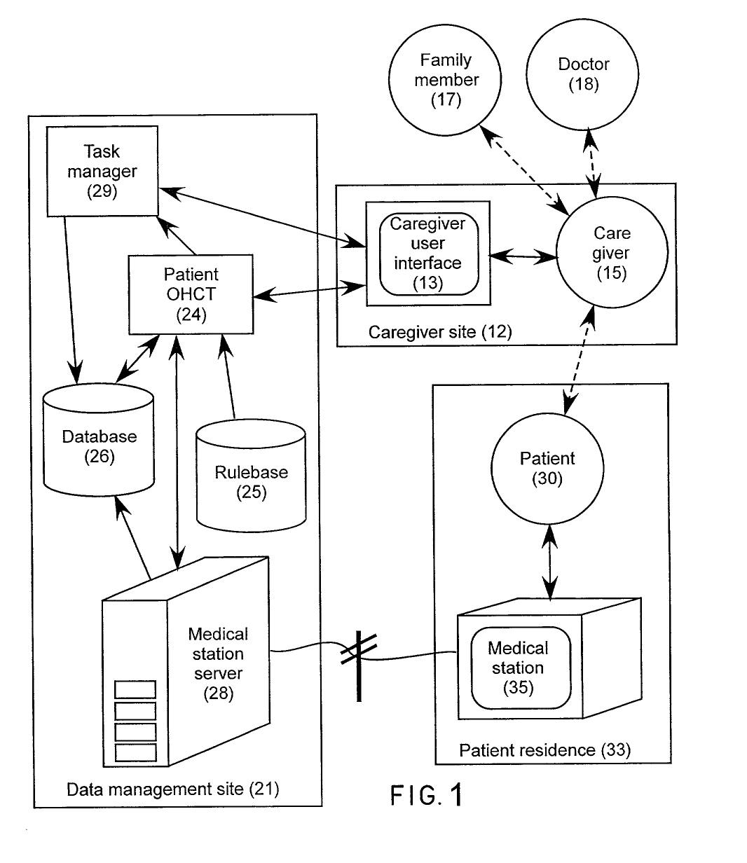

FIG. 1 shows the relationship between the patient 30 at his residence 33 and the remainder of the medical management system 10. The partitioning depicted is typical and exemplary but other partitioning are within the scope of the invention. The patient can interact with his medical workstation 35 or with his voice communication line. The medical workstation 35 is a device or series of devices that interacts with the patient by collecting medical information and by providing information on a computer terminal. Voice communication is carried on with a CG 15 who is at a remote CGS 12. The MS 35 is in communication with the DMS 21 either through a network or via telephone modem linkage.

The caregiver 15 will typically have many client patients and be in communication with others who are involved with the patient 30. In the figure, the patient's doctor 18 and a family member 17 are shown.

The CG interacts with a computer as well. This CGUI 13 connects the CG 15 to the data management site 21. Typically the caregivers and DMS 21 are in the same facility and communicate over a local network, however a wide area network with the CGS 12 in a remote location is also an option.

The components at the DMS 21 include medical station server 28 that collects data from multiple medical stations 35 and provides information back to them. The medical station server 28 also stores data in the database 26, informs the OHCT 24 that data has arrived for a particular patient, and gets information to pass back to the patient from that OHCT 24. The database stores data from each patient 30, tasks performed by each caregiver 15, and outcomes determined by each OHCT 24. The rulebase 25 stores rules governing the tasks required to care for each type of patient, the types of information that must be provided to each type of patient or the data that must be gathered from each type of patient. A patient OHCT 24 maintains the knowledge of a specific patient 30. This knowledge of patients includes what type of patient they are, what stage of wellness or illness they are in, what knowledge they possess, and what healthcare tasks have been performed for their benefit. This knowledge is updated every time new data is received from a patient 30 or a task is performed for this patient by a caregiver 15. Finally, the task manager 29 maintains a list of tasks to be performed for each patient 30 by a caregiver 15. Such tasks are generated by each patient OHCT 24 and by caregivers themselves. Once completed, the caregiver informs the task manager 29, which saves it in the database and deletes it from its list.

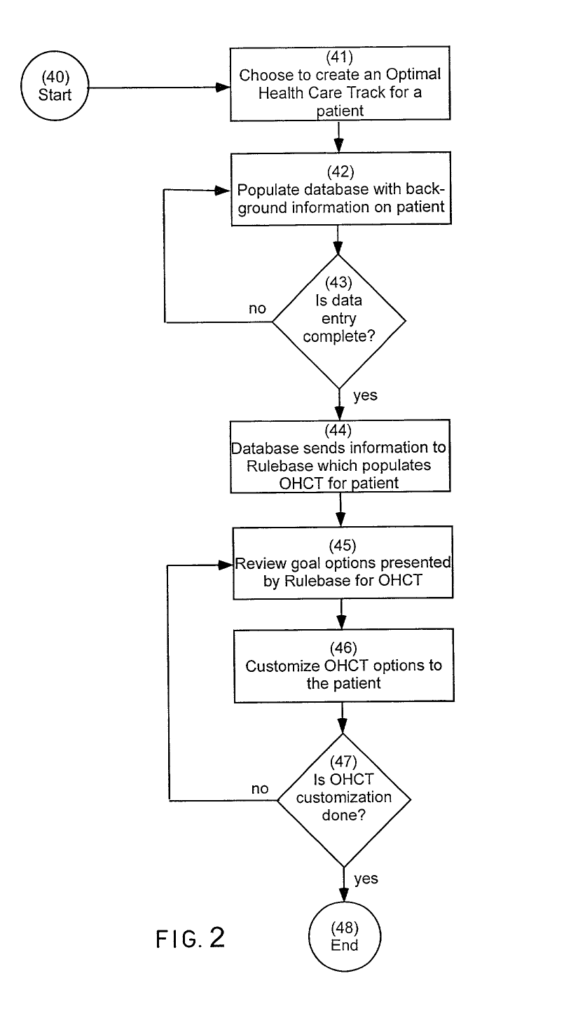

FIG. 2 shows an initial series of transaction that take place when a new patient 30 becomes part of the medical management system 10. At the start 40 a caregiver 15 chooses to create an OHCT 24 for a new patient 41. The caregiver 15 is queried, via the CGUI 13 about their knowledge of the patient 30. This knowledge entry 42 is performed via the CGUI. The entry process interates 43 until all available knowledge is gathered. This knowledge is collected by the OHCT 24, which stores it in the database 26. This knowledge determines which rules from the rulebase 25 are applicable 44 for that patient 30. As the OHCT 24 retrieves each rule form the rulebase 25, the caregiver 15 reviews each rule 45 for that particular patient 30. Using caregiver's knowledge of the patient 30 the caregiver 15 will customize each rule 46 for that patient 30. Each customization parameter for that patient will be stored by the OHCT in the database 26. This process will interate 47 through all the rules generated by the rulebase 25. At his point the initialization of the OHCT 24 is complete 48.

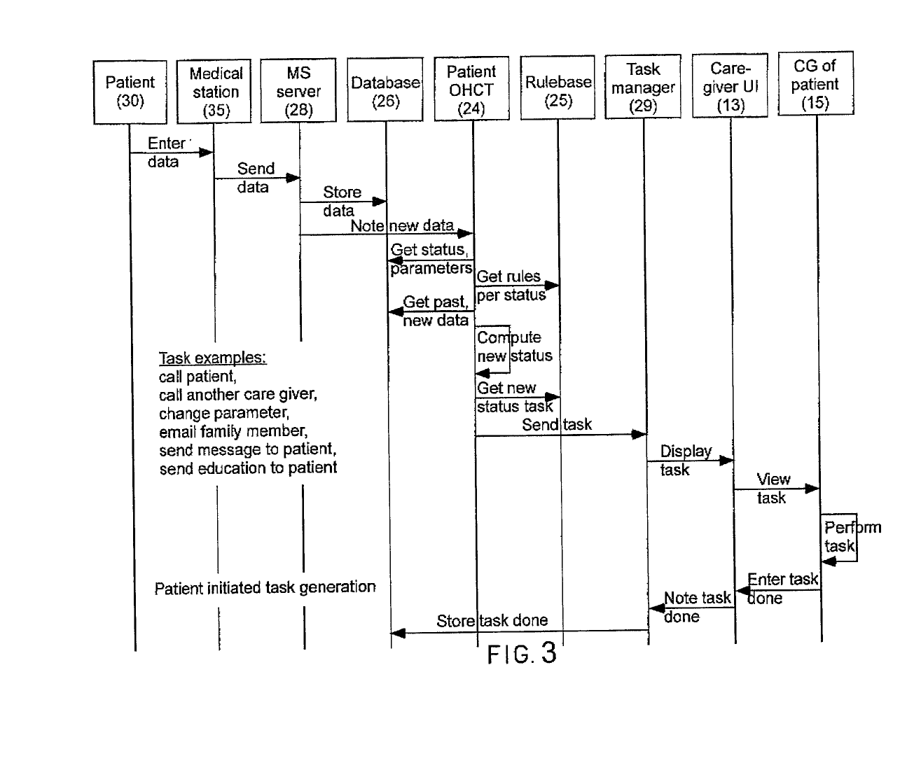

FIG. 3 shows the interactions within the medical management system 10 when the patient 30 enters medical data, resulting in automatic task generation. The patient 30 first uses the medical station 35 to collect this data either through hand entry or through device measurement of clinical parameters. The medical station 35 sends this data to the medical station server 28. The medical station server 28 stores the data in the database 26 with that patient's other data and notifies that patient's OHCT 24 that data has been stored for that patient 30. The OHCT 24 gets the current knowledge on that patient from the database 26 and then, using the knowledge and customization parameters for that patient, retrieves the rules for that patient from the rulebase 25. Using these rules, the OHCT 24 retrieves all the relevant data on the patient from the database 26 to compute the status of the patient 30. This status updates the knowledge about the patient and thus, based on a rule, could generate a new task to be performed for the patient 30 by the caregiver 15.

An example might be that the OHCT knows the patient has stage two congestive heart failure. A rule may be that if the patient's weight increases over the last two days then the patient's doctor should be called. The parameter unique to that patient may be that the amount of increase to be worried about is 2 pounds. The OHCT would retrieve data from the past two days, compute the change and send the task of calling the doctor to the task manager 29 if this change was over 2 pounds.

After the OHCT 24 sends a task to the task manager 29, the task manager 29 will display it via the CGUI 13 to the caregiver 15. When the caregiver 15 has performed the task, the CGUI 13 is used to note to the task manager 29 that it has been completed. The task manager 29 stores this task completion information in the database 26.

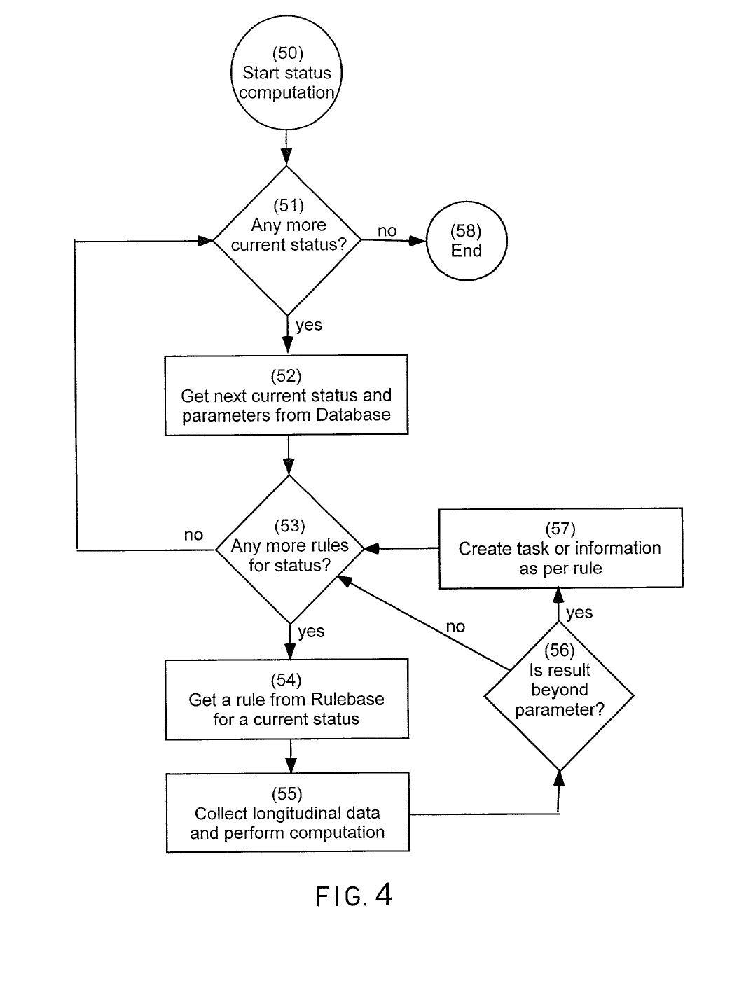

FIG. 4 shows, in more detail, how the OHCT 24 computes the new status of a patient 30. This occurs whenever new data is made available for the patient 30. For each type of status 51, for example health status or patient knowledge status, the current status and patient customization parameters are retrieved 52 by the OHCT 24 from the database 26. For each rule related to that status 53 the rule is retrieved 54 from the rulebase 25. The OHCT 24 then retrieves the data 55 necessary to determine the outcome of that rule from the database 26. If it is outside of that patient's parameter for that rule 56, then the task or information dispersal 57 is created. If not, then the next rule is retrieved 53. If no more rules are available for that status then the next status is retrieved 51. If there are no more current status then the status computation ends 58.

The congestive heart failure example above relates to this figure. An information dispersal example may be related to when a patient starts a new medication and includes this information in the data sent to the database. At this point, the rule would be to assume the patient 30 has not been adequately informed on how best to take the medication. The first task generated would be send this information to the patient via the medical station 35 and then to query the patient about its use to determine whether the information was understood. The subsequent data received from the medical station 35 would change the knowledge status of the patient (the patient now understands about the medication) or the patient still needs training and the medical station feedback didn't work. At this point, a task may be created for the caregiver 15 to call the patient 30 to personally explain the medication.

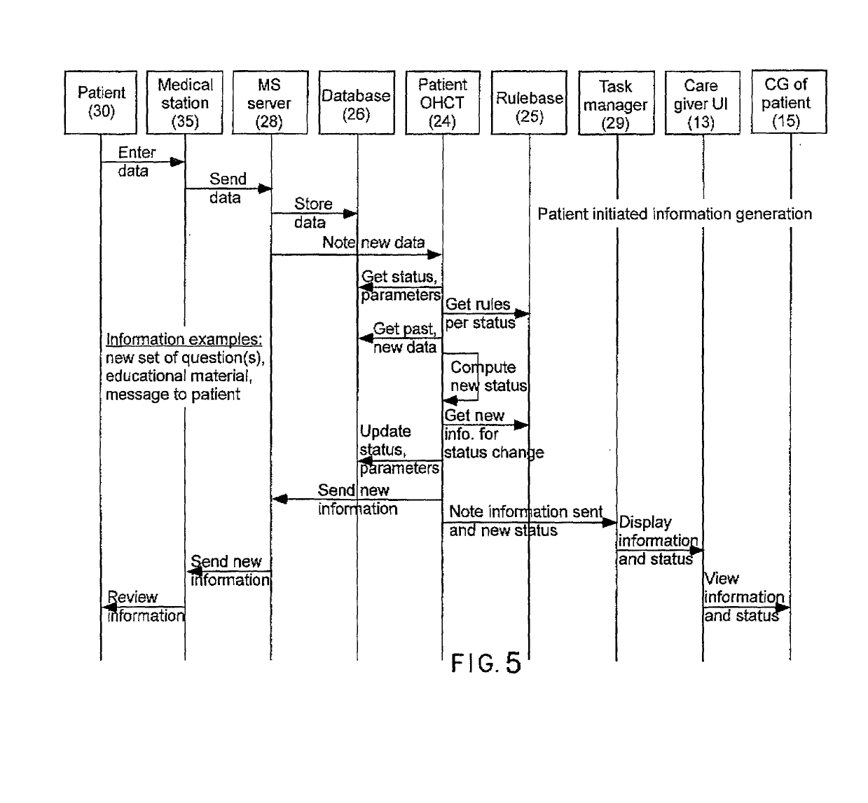

FIG. 5 shows the interactions within the medical management system 10 when the patient 30 enters medical data, resulting in automatic information generation. The first part of this method also occurs in FIG. 3 and is explained in further detail in FIG. 4.

Continuing from those figures after the new status is computed by the OHCT 24, this new status is stored for future reference. Subsequently the information is forwarded by the OHCT 24 to the medical station server for transfer. The next time the patient's medical server 28 connects with the medical station server 28, this information is downloaded to the medical station 35. The next time the patient 30 interacts with the medical station 35, this information is provided to the patient 30. Similarly, the fact that this information was provided to the patient is forwarded to the task manager 29, which displays this information to the patient's caregiver 15 via the CGUI 13.

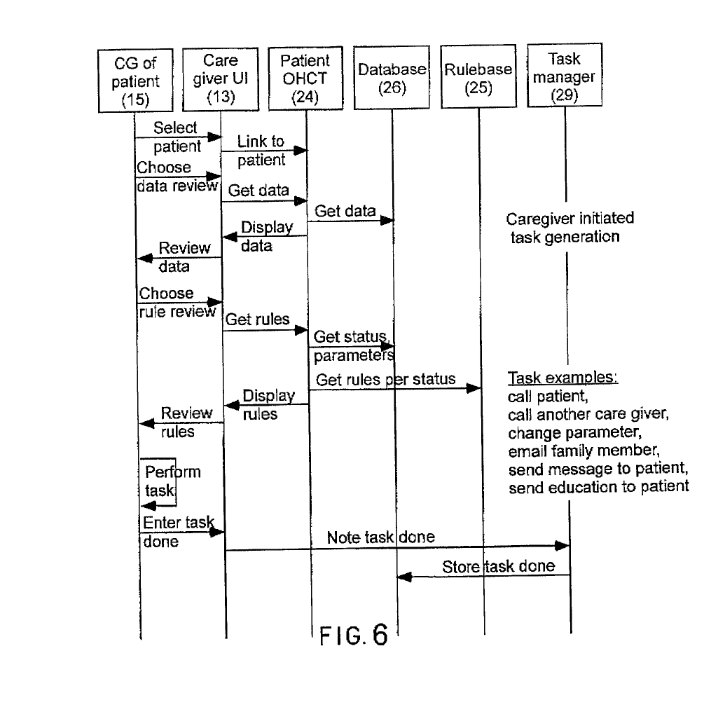

FIG. 6 shows the interactions within the medical management system 10 when the caregiver 15 initiates a task. Typically, this will occur when the caregiver is reviewing patient data via the CGUI 13. To do so, the caregiver will link to the patient's OHCT 24, which retrieves the data from the database 26. The OHCT 24 will display the data in a manner the caregiver wishes, based on the knowledge of what type of data is available. The caregiver 15 may wish to base any new task on the rules that have been established for that type of patient. If so, these rules will be displayed on the CGUI 13 by the OHCT 24, which has retrieved these rules from the rulebase 25, and shown how they relate to the patient 30 by the patient's customization parameters. If the caregiver 15 wishes to perform a task based on this review of data and rules then the task is noted to the task manager 29, which stores this task in the database.

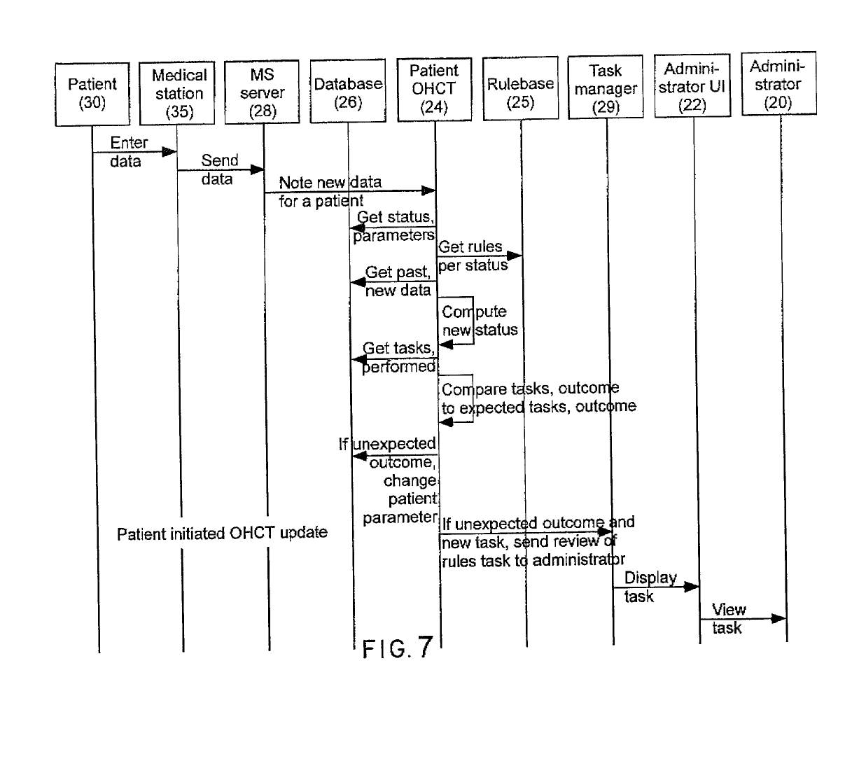

FIG. 7 shows the interactions within the medical management system 10 when the patient 30 enters medical data, resulting in an automatic OHCT update. The first part of this method also occurs in FIG. 3 and FIG. 5 and is explained in further detail in FIG. 4. Continuing from those figures, after the new status is computed by the OHCT 24, the tasks that have been performed since the last status computation are retrieved from the database 26. The rule that was used to create the task is reviewed and the actual outcome of that task is compared to the expected outcome. Using a previous example, is the patient 30 was told about a new medication via the medical station 35, the expectation was that the patient would retain this knowledge. If this was not the case, then the rule may be customized for this patient so that this step is skipped in the future and instead a phone call to the patient is the first step taken whenever a new medication is begun. Such a rule parameter change is sent to the task manager 29, which routes it via an administrator user interface 22 to a system administrator 20. This administrator 20 reviews the OHCT parameter change and either lets it go through or changes it, for example by initiating a call to the patient's doctor to have the doctor's staff explain medication better when it is prescribed.

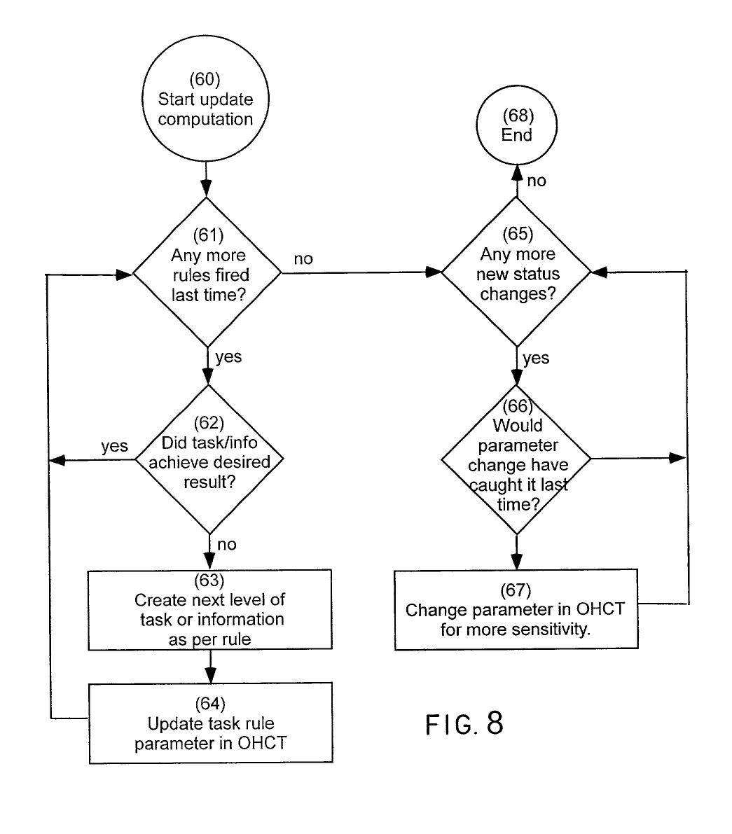

FIG. 8 shows, in more detail, how the OHCT 24 automatically updates rule parameters for a patient 30. There are two different types of rules that are reviewed by this procedure: task/information generation rules and status change rules. At the start of this procedure 60 each rule that initiated a task or information is reviewed 61. The actual outcome is compared to the expected outcome 62. If they are the same then the next such rule is retrieved 61. If they are different then the next level of task or information is created for that patient 30. In our above example, the patient is called about the new medication instead of having information sent via the medical station 35. As explained above for FIG. 7, the parameter for this patient is also updated so the rule generates this task level whenever a new medication is begun. In the other example of task generation, if the congestive heart failure patient was not helped by the call to the doctor 18 then the next level task may be a call to the doctor with follow-up information sent to the patient via the medical station 35. After this parameter update 64, the next rule is retrieved 61. If there are no more such rules then the status change rules are reviewed.

In this part of the procedure, each status change is reviewed 65. For example if the congestive heart failure patient was found to have increased 2 pounds in a two day period then previous data is retrieved. Each instance of change in the patient's weight is reviewed to see when a smaller change predated this level of change and when such a change did not. If it is found that, for example, 90% of the time a change of 1.5 pounds the previous two days preceded a change in 2 pounds the following two days, and only 10% of the time it did not, then the change parameter for that patient rule can be changed from 2 pounds to 1.5 pound per two day period. If the no earlier change can be found 66 then the next status change is reviewed 65. If an earlier change is found 66, then this parameter is changed for that patient's OHCT 24. When there are no more status changes 65 the procedure ends 68.

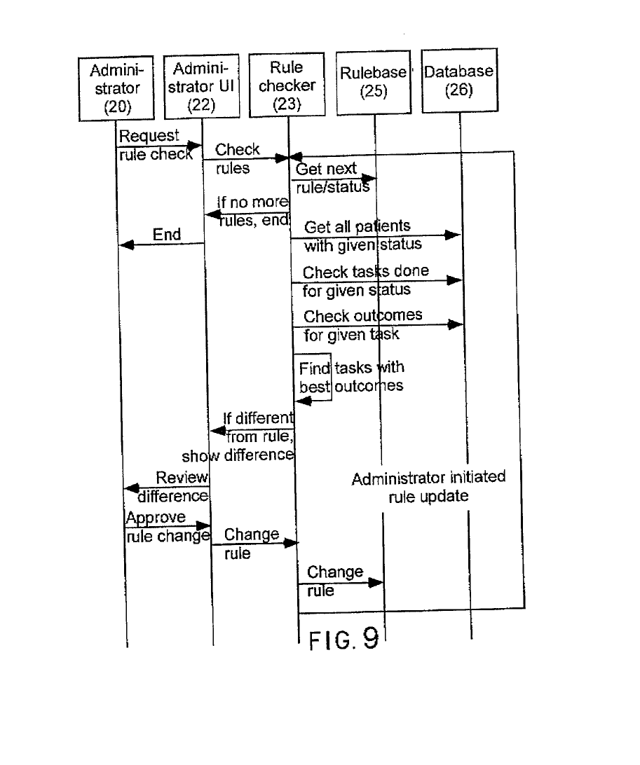

FIG. 9 shows the interactions within the medical management system 10 when the administrator initiates a rule review. Typically, this will occur regularly (i.e. once per month) in order to gain maximum utility from data that has accumulated. The administrator 20 will use the administrator user interface 22 to request a rule checker 23 to check all the rules in the rulebase 25. Each rule is reviewed in turn. For each rule, all the patients with the status governed by that rule are retrieved. Next, the tasks that have been performed on those patients are retrieved. These can either be tasks that have been generated by the OHCT 24 or by the caregiver 15. The subsequent outcomes of those tasks are retrieved as well. The tasks and outcomes are compared. For example, if sending information on new medications via the medical station 35 only gives the expected outcome 20% of the time while the phone call to the patient works 80% of the time then the phone call can become the default first step. Such an outcome can also be a flag to the administrator that the type of information presented to the patient 30 via the medical station 35 needs to be improved. In this case, the newer information could become the default first step. Any change of rules in the rulebase 25 is initiated by the administrator 20 after outcome differences are presented by the rule checker 23.

This overview of outcomes to modify the rulebase 25 can be directed by randomly choosing participants for two clinically equivalent set of rules which provide two different sets of tasks for a given patient condition. For example, for patients with high blood pressure, one group may be sent instructions on managing their condition via mailed literature and another group sent it via the medical station 35. If, after a sufficient time of collecting outcome data, there were no differences between the groups then the least expensive method would be chosen by the administrator 20 to be the default method to use with such patients. If however, the most expensive method were clearly the best for the patients clinically then that method would be chosen as the default.

What is claimed is:

1. A computer system for providing optimized heath care tracking and individualized communication and between a heath care professional care giver and a heath care user comprising:
a care manager (CM):
a patient (HCU)
a telephone link between CG and HCU;
a computer system (LN) operated by said CM having;
a rulebase RB;
a database DB;
said RB connected to said DB
a taskmanager (TM) coupled to said RB and coupled to said DB;
a CG user interface;
a HM database server (HMDBS);
a home monitor (HM);
HM coupled to HCU;
HM makes physiologic measurement on HCU;
HM connected to HMDBS;
said TM including software process(es) for;
initialing communication between HM and HMDBS to collect phys data from HCU, at a time OR event dictated by RB;
scheduling a telephone communication between CG and HCU;
tracking scheduling;
said RB including software process(es) for;
continuously improving TM based on HCU outcomes detected and tracked by CG communication and HM measurements;
interrogating the DB to determine HCU outcomes.
